(19) United States
(12) Patent Application Publication
(10) Pub. No.: US 2019/0155585 A1
(43) Pub. Date: May 23, 2019

(54) DYNAMIC HYBRID RENDERING

(71) Applicant: General Electric Company, Schenectady, NY (US)

(72) Inventors: Joseph JUNE, Pleasanton, CA (US); Eric INGRAM, Pleasanton, CA (US)

(21) Appl. No.: 15/815,851

(22) Filed: Nov. 17, 2017

(51) Int. Cl. G06F 9/44; G06F 17/22; G06F 17/30

(52) U.S. Cl. CPC G06F 8/38; G06F 17/30905; G06F 17/2247; G06F 9/4443

(57) ABSTRACT

The example embodiments are directed to a system and method for generating dynamic rendering data based on a rendering platform of a target device. In one example, the method includes receiving a request to download application data to a target device, detecting a type of rendering platform of the target device from among a plurality of types of rendering platforms, dynamically generating application rendering data for the target device, the dynamically generated application rendering data comprising common logic for use by any type of the plurality of rendering platforms, and dynamic rendering metadata that corresponds to the detected type of rendering platform of the target device and that controls rendering of the common logic on the target device, and transmitting the dynamically generated application rendering data to the target device.

### BACKGROUND

Machine and equipment assets are engineered to perform one or more tasks as part of a business process. For example, assets can include, among other things and without limitation, industrial manufacturing equipment on a production line, drilling equipment for use in mining operations, wind turbines that generate electricity on a wind farm, transportation vehicles such as trains and aircraft, and the like. As another example, assets may include devices that aid in diagnosing patients such as imaging devices (e.g., X-ray or MRI systems), monitoring equipment, and the like. The design and implementation of these assets often involves both the physics of the task at hand, as well as the environment in which such assets are configured to operate.

Over time, hardware components of an asset can experience wear and tear and software components can require updates and replacement. In some instances, assets can even experience hardware or software failures. To address these issues, many manufacturers and third parties provide field service to ensure that an asset operates smoothly. Field service can include maintenance, updates, and repairs which are often provided by or otherwise controlled by a technician. As cloud-based computing and industrial manufacturing continue to merge, service-based software is becoming more integrated within a cloud environment. For example, a field service software application can provide a comprehensive, cloud-based, and mobile enterprise solution that manages the service delivery end-to-end process for a service technician enabling manufacturers and service providers to grow service revenues, increase service efficiencies, improve customer experience, and address compliance requirements.

Technicians often rely on the field service software application as part of their day-to-day operations. For many technicians, the field service software is downloaded to a mobile client device (e.g., tablet, smartphone, etc.) or a laptop or desktop computer at the beginning of the day or at the start of a work order, and is updated as the technician progresses through tasks. The field service software may provide a refined interface, consistent access, and targeted service workflows. Through the field service software, the technician can successfully complete complex work orders, present service reports for customer signature, and provide dynamic pricing of labor, parts and products while in the field.

In order to provide a rich user experience, software applications (such as field service software) often utilize native components of an operating system and/or a web browser of a target device depending on which component is performing the rendering. However, operating systems and web browsers have different rendering capabilities and attributes. Furthermore, different operating systems have different rendering capabilities between themselves. For example, different mobile operating systems are specialized for different sets of mobile devices and use cases. As a result, developers often generate multiple versions of an application (and separate rendering logic) for different rendering platforms (e.g., mobile application, web browser, etc.)

### SUMMARY

Embodiments described herein improve upon the prior art by providing a dynamic hybrid rendering of a software application for a multi-channel environment. The dynamic hybrid rendering may use common application logic (e.g., display logic, business logic, etc.) that is common for all types of rendering platforms and dynamic rendering metadata that is unique to the type rendering platform. The dynamic rendering metadata may be used to trigger native components that are unique to the type of rendering platform. As a result, the application logic can be shared across each rendering platforms without the need to generate different versions of the application. According to various aspects, each channel may be associated with a different rendering platform such as a mobile, web browser, etc., or a different type of operating system (e.g., iOS®, ANDROID®, WINDOWS®, etc.), and the like. A software application may be downloaded from a web server to a user device. When downloading the application to the user device, the web server may detect a platform environment of the user device and generate a dynamic download for the user device. The dynamic download may include platform-agnostic application logic that is common for all operating environments and also dynamic metadata that is platform-specific for the user device. The dynamic metadata may interact with platform-specific native rendering components for various display items such as background, layout, user interface features, buttons, fields, and the like, as well as business logic such as workflows of the application data.

In an aspect of an example embodiment, a computer-implemented method includes receiving a request to download application data to a target device, detecting a type of rendering platform of the target device from among a plurality of types of rendering platforms, dynamically generating application rendering data for the target device, the dynamically generated application rendering data comprising common logic for use by any type of the plurality of rendering platforms, and dynamic rendering metadata that corresponds to the detected type of rendering platform of the target device and that controls rendering of the common logic on the target device, and transmitting the dynamically generated application rendering data to the target device.

In an aspect of another example embodiment, a computing system includes a network interface configured to receive a request to download application data to a target device, and a processor configured to detect a type of rendering platform of the target device from among a plurality of types of rendering platforms, and dynamically generate application rendering data for the target device, the dynamically generated application rendering data including common logic for use by any type of the plurality of rendering platforms, and dynamic rendering metadata that corresponds to the detected type of rendering platform of the target device and that controls rendering of the common logic on the target device, wherein the processor is further configured to control the network interface to transmit the dynamically generated application rendering data to the target device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a system for downloading application data in accordance with an example embodiment.

FIG. 2 is a diagram illustrating a process of dynamically determining rendering metadata based on a rendering platform of a target device in accordance with an example embodiment.

FIG. 3 is a diagram illustrating a rendering architecture of a target device in accordance with an example embodiment.

FIG. 4 is a diagram illustrating an application architecture which may be rendered by a target device in accordance with an example embodiment.

FIG. 5 is a diagram illustrating a method for dynamically generating rendering data for a target device in accordance with an example embodiment.

FIG. 6 is a diagram illustrating a computing system for dynamically generating rendering data for a target device in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Example embodiments are directed to a hybrid rendering system and method for rendering application data on the screen of a user device such as a mobile device, a desktop, an appliance, a smart wearable device, a server, or the like. Hybrid rendering uses both JavaScript components and native components when performing rendering. A host platform such as a server, cloud platform, database, or the like, which hosts or otherwise provides application data to multiple different client devices via a network may receive a request for application data from a target device. Here, the system may detect a rendering platform of the target device, for example, whether the target device is performing rendering using a web browser or a mobile operating system. Furthermore, if the target device is performing rendering using a mobile operating system (i.e., a mobile app), the system may further detect which mobile operating system is being used. Based on the detected rendering platform, the system may dynamically generate rendering metadata which is to be used by the detected type of rendering platform of the target device to render common logic of the application.

The common logic may be used/downloaded regardless of the rendering platform. The common logic may include code, instructions, or the like, including display logic for rendering graphical features such as layouts, buttons, input fields, user interfaces, and the like, which may be rendered on a screen by a rendering platform. As another example, the common logic may include business logic such as a workflow of the application which is triggered by selections being made within the application content. Both display logic and business logic may be common across the types of rendering platforms described herein.

In order to enhance the rendering for a particular target device, the system may determine a type of rendering platform being used by the device, and add platform-specific rendering metadata to the common logic that enables the rendering platform of the target device to use respective native components thereof when rendering the common display logic. The rendering metadata may include unique triggers associated with the type of platform which instructs the platform on how to render the common logic using native components that are specific to the detected rendering platform. As a result, a richer display may be provided to the user based on a device type of the user.

The dynamic rendering metadata may be selected based on a type of the rendering platform being used by the target device. For example, the web server may select different and unique rendering metadata for a target device based on whether the rendering platform of the target device is a mobile app on an Apple iOS® device, Google ANDROID® device, Microsoft WINDOWS MOBILE® device, and the like. As another example, the web server may select unique rendering metadata when the application is to be rendered using a web browser (e.g., WINDOWS EXPLORER®, etc.) instead of a mobile operating system. In other words, each distinct rendering platform may have its own unique native rendering components and the rendering metadata may be used to trigger the different native rendering components based on the detected target platform.

The system described herein may be a server, a cloud instance, or the like, which is deployed in a platform such as a cloud platform computing environment in an Internet of Things (IoT) or an Industrial Internet of Things (IIoT) platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

Service technicians are often used to manage the operation and repair of assets while out in the field. Field service software can be used by a technician while performing various duties such as maintenance, repairs, part-replacement, cleaning, inspecting, and the like. The field service software may provide the technician with a daily schedule, instruction manuals, work orders, parts lists, signed documents, location-based maps, and the like. For example, the field service software application may provide a user interface that enables consistent access and targeted service workflows for a group of technicians out in the field and interacting with the same back-end mobile application database file. Through the field service software, the technician can successfully complete complex work orders, present service reports for customer signature, and provide dynamic pricing of labor, parts and products. Furthermore, as updates are made by other technicians to the back-end database, and updates are made by a technician to a local database, the sync gateway can merge the changes, perform conflict resolution, and update both the back-end database and the local client database accordingly.

The system described herein can generate mobile application data such as a database file that is directly consumable by a mobile client such as a laptop, a tablet, a smart phone, or the like. The mobile application database file may include unique user-specific service flow manager configuration data to support client-side custom application behaviors (i.e., business logic) and which is downloaded to the client device with dynamically determined rendering metadata based on a rendering platform of the client device. For example, the server may transmit an extensible set of service related custom graphical objects and layouts for use in field service and also supports delivery of objects and fields in accordance with the Sales Force Dot Corn (SFC) security model.

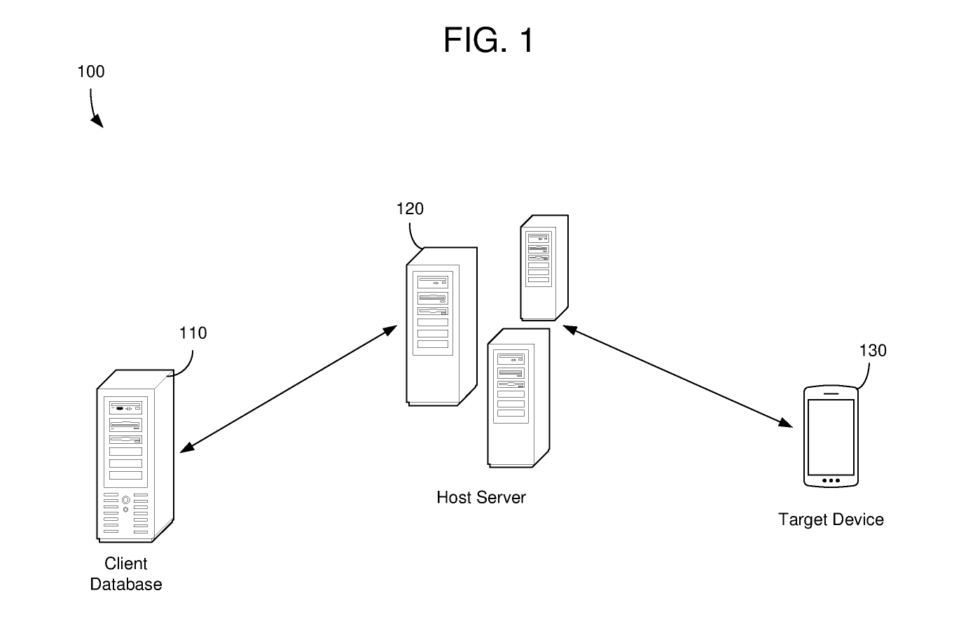

FIG. 1 is a diagram illustrating a system 100 for downloading application data in accordance with an example embodiment. In the example of FIG. 1, the system 100 includes a client database 110, a host server 120, and a target device 130, which may be connected to each other via a network such as the Internet, a private network, or a combination thereof. The host server 120 may be a web server that hosts a mobile application that is used by many different clients to provide client-specific application data to respective users thereof. In this example, target device 130 receives application data from the client database 110 via the host server 120. For example, the data may be downloaded to a mobile application that is executed by the target device 130 and which is hosted by the host server 120. As another example, the data may be downloaded to a web browser on the target device 130 from the host server 120. According to various embodiments, the host server 120 may dynamically generate application data being downloaded to the target device 130 to thereby perform rendering based on a type of rendering platform of the target device 130.

As a non-limiting example, the host server 120 may host a mobile software application including rendering data which is used by the target device 130. The rendering data may include common logic which include both display logic (i.e., layout, background, UI, graphical elements, etc.) and business logic (e.g., functions, behavior, etc.) of the application data. The application data (including the rendering data) may be downloadable to the target device 130 for use by the client (e.g., field service data). It should also be appreciated that many client devices may interact with the mobile application software such as devices of other technicians from the same client which operate on the same back-end data. As a result, changes may be periodically or continuously made to the client's mobile application data stored on the host server 120.

In operation, the target device 130 may transmit a request to the host server 120 to initiate a download of a mobile application file (e.g., SQLite database file). The request may include configuration information of the target device 130 that enables the host server 120 to detect which rendering platform is being used by the target device 130. For example, the configuration information may include an authentication token, a user-profile that identifies user-specific data of the mobile application to be downloaded, a device type, an operating system, a web browser, and the like, of the target device 130.

In response to the request, the host server 120 may transfer/download the mobile application data including client data received from the client database 110, and build the mobile application file for delivery to the target device 120. For example, the host server 120 may include a gateway such as a microservice or other software program executing within the host server 120 which handles the data transfer processes. The host server 120 generates or otherwise builds the mobile application database file for the target device 130 and transfers the mobile application file to the target device 130 via a network connection such as the Internet. There are multiple types of downloads including an initial sync download and a subsequent incremental sync download.

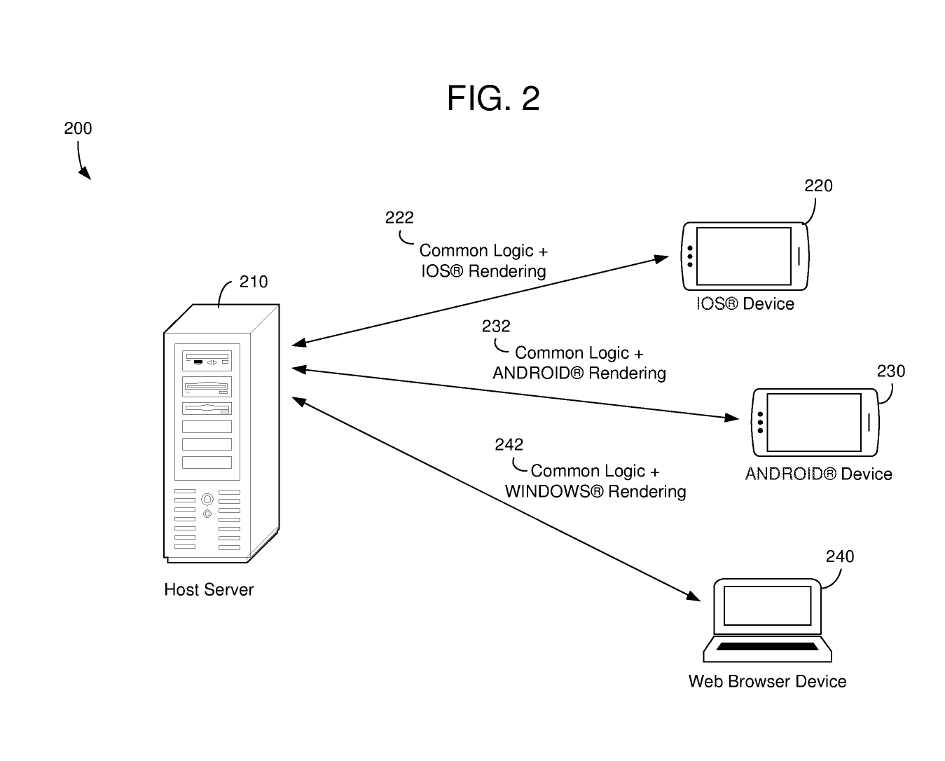

FIG. 2 illustrates a download process 200 for the transfer of dynamically determined rendering metadata to be used based on a rendering platform of a target device in accordance with an example embodiment. In this example, a host server 210 determines different rendering data to be used by target devices 220, 230, and 240, to render common application logic. In this example, each of the target devices includes a different rendering platform (e.g., iOS®, ANDROID®, web, etc.) which dictates which native rendering components are being used. Each of the target devices 220, 230, and 240, may provide an identification to the host server 210 indicating the native rendering platform being used. For example, the identification may be included in a download request, a response to a query from the host server 210, a notification message, and the like. The identification may also be built into a metadata model for profiling and targeting by the host server 210 which enables the host server 210 to target user groups or data of particular types which are linked by a common rendering platform.

Based on the rendering platform type, the host server 210 generates dynamic rendering metadata for the download of application data to each of the target devices 220, 230, and 240. For example, the host server 210 may include common logic plus dynamic rendering metadata which is determined by the host server 210 and which uses one or more of a ReactJS library and a React Native framework on the target device to control the rendering of the common logic. The rendering metadata is used to trigger native rendering components of the rendering platform for rendering the common logic and also identifies what common logic to render. The rendering metadata may be stored in different formats and transmitted in different formats. As an example, the metadata may be assembled in a JavaScript Object Notation (JSON) file including a bunch of objects (node.objects) which define how the common logic is to be consumed/rendered. The common logic may include visual components (i.e., display logic) of the software application that are to be rendered such as text boxes, buttons, layouts, banners, backgrounds, user interfaces, and the like. The common logic may also include business logic including a workflow and behaviors of the application which are performed based on selections and operations of the application (e.g., when this button is selected, this page closes and another page opens, etc.).

Referring to the example of FIG. 2, when the application data from the host server 210 is downloaded to the iOS® mobile device 220, dynamic rendering metadata 222 controls rendering of the common logic using native iOS® rendering components. As another example, when the application data from the host server 210 is downloaded to the ANDROID® mobile device 230, dynamic rendering metadata 232 controls rendering of the common logic using native ANDROID® rendering components. As another example, when the application data from the host server 210 is downloaded to the web browser of target device 240, dynamic rendering metadata 242 controls rendering of the common logic using native web browser rendering components. By taking advantage of different native rendering components on the platform while maintaining the same common application logic, the system delivers a relatively unique and targeted user experience depending on device/OS type without the hassle or requirement of developing different software versions for each platform. One of the benefits is that the same display/business logic can be manipulated to display and render differently based on the different rendering platforms thereby taking advantage of native rendering components of each platform.

In some embodiments, the host server 210 may provide an authoring environment through which a developer can define display logic such as graphical objects, UIs, layout, etc. which results in a common metadata model that gets generated. When the developed application is downloaded, the host server 210 determines dynamically which rendering metadata to provide to the download data based on a rendering platform of the target device. Accordingly, the authored application logic may be rendered using a set of native components unique to the target device. The metadata determines what rendering components are triggered on the target platform. According to various aspects, the business logic (i.e., the display logic) may be relatively precise based on the client needs. Furthermore, the system may provide a multi-channel experience based on how the information has to get consumed at each channel (iOS® app, ANDROID® app, web browser, etc.) The same logic is able to be manipulated to display differently based on the different rendering platforms using the rendering metadata.

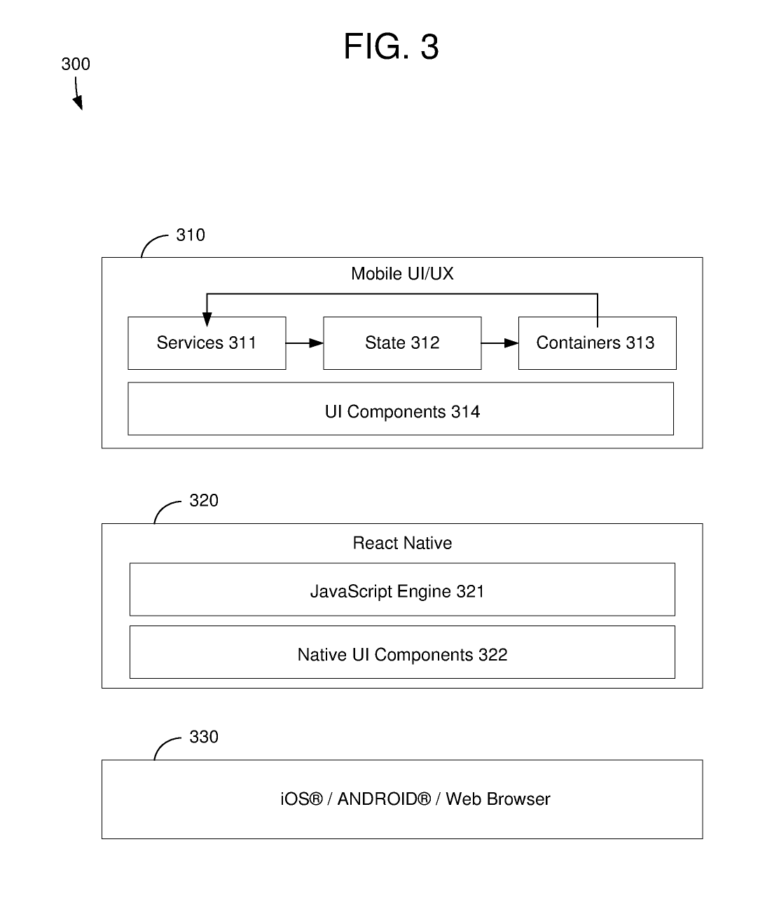

FIG. 3 illustrates a rendering architecture 300 of a target device which includes a user interface (UI) and user experience (UX) state management layer 310, a react native layer 320, and an operating system layer 330. In this example, the UI/UX layer 310 includes services 311, state 312, containers 313, and UI components 314. Meanwhile, the react native layer 320 includes a JavaScript engine 321 and native UI component rendering 322. The OS layer 330 always works that same regardless of the rendering platform.

The UI/UX layer 310 provides a management flow of how rendering is performed for the target platform. The rendering of the UI of the application depends on the state. The data services 311 provides the metadata for rendering which is converted by the react native layer 320 into an application state 312 which then passes into a container 313 (business logic) and then the UI component 314 which may include the containers 313. According to various aspects, the services 311 coming in from the host server controls the native UI components 322 of the react native layer 320. Meanwhile, the state 312 represents the current state of the application (state representing what the app is doing) and what the user is doing on the device in combination with what the metadata allows them to do. The containers 313 include the business logic of the application which is driving the display logic based on what the user is doing/interacting with on the application. The containers 313 are generated based on the business logic coming in from the data services 311. The react native layer 320 is a bridge between JavaScript 321 and native rendering 322 components. The metadata from the data services 311 dictates whether to use JavaScript 321 or native rendering 322 components to render logic included in the containers 313 and UI components 314. The rendering may take an intermediate representation from the code and converts it into a native UI.

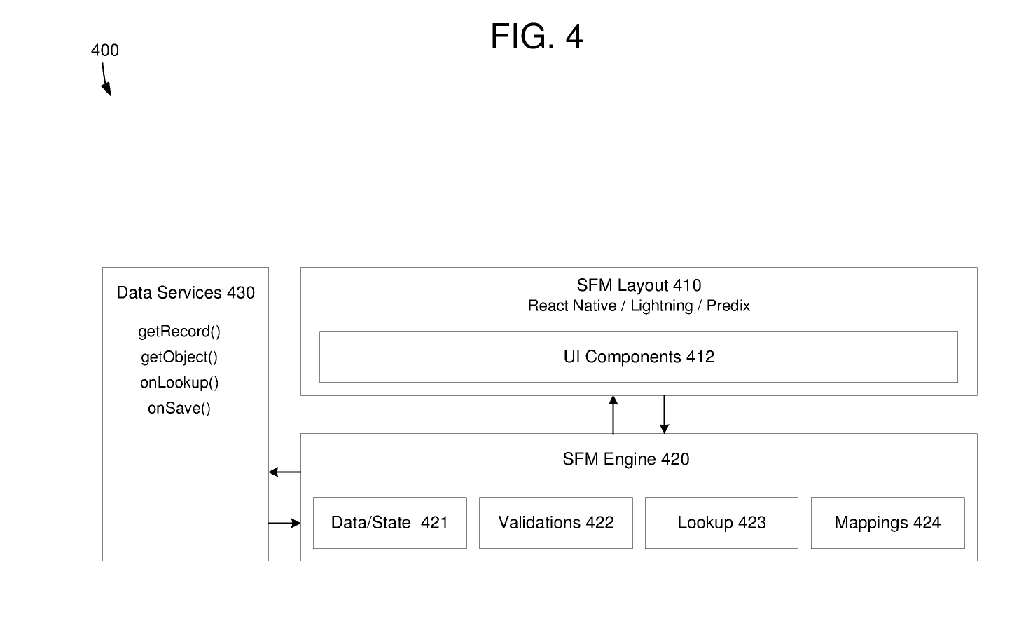

FIG. 4 illustrates an architecture of an application 400 which is installed on a target device in accordance with an example embodiment. The display screen of the target device is realized based on the rendering metadata. Referring to FIG. 4, the application 400 includes a layout 410 and UI components 412 for display. The layout 410 and the UI components 412 may also include the metadata that is to be used to control rendering of the application data. The metadata may be configured by a host server and transferred to the target device during a download of the application 400.

The engine 420 represents the business logic of the application 400 which knows how to interpret the metadata of the layout 410 and the UI components 412. The engine 420 renders the layout 410 and the UI components 412 according to the metadata. The engine 420 also maintains a record of the data 421, handles validations 422 on the data record (e.g., save) based on the metadata, performs a lookup 423 such as an account by name to link to the record, and mappings 424 that define how data is mapped from one record to another. The layout 410 interacts with the display logic based on the metadata. Meanwhile, the data services 430 illustrates how the SFM engine retrieves data and metadata and handles transactions using various services which may include getrecord( ), getobject( ), onLookup( ), onSave( ), and the like.

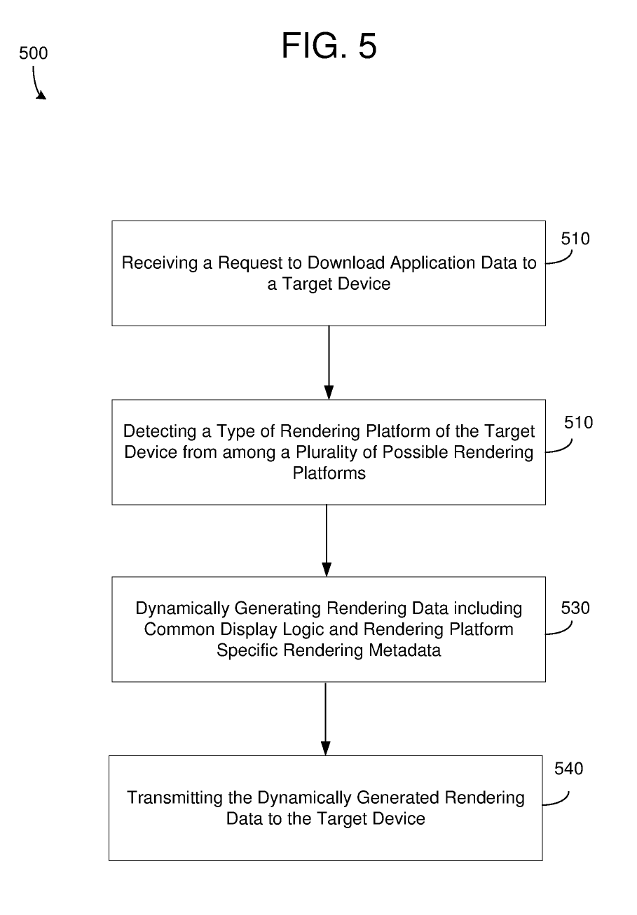

FIG. 5 illustrates a method 500 for dynamically generating rendering data for a target device in accordance with an example embodiment. For example, the method 500 may be performed by a computing system such as the host server 120 shown in FIG. 1, the host server 210 shown in FIG. 2, or the like. Referring to FIG. 5, in 510, the method includes receiving a request to download application data to a target device. The request may be an initial request to download the application for the first time or it may be an incremental or subsequent request to synchronize the application data between the host server and the target device or receive newly generated application data from the host server.

In 520, the method includes detecting a type of rendering platform of the target device from among a plurality of possible types of rendering platforms. For example, detecting the type of rendering platform may include detecting a type of mobile operating system of the target device from among a plurality of types of mobile operating systems (e.g., iOS®, ANDROID®, etc.). As another example, detecting the type of rendering platform may include detecting whether the download application data is to be executed via a mobile app or a web browser (e.g., INTERNET EXPLORER®, SAFARI®, CHROME®, etc.) of the target device. In some embodiments, the detection may include detecting both the type of operating system and whether the application is being executed via the web browser or via a mobile application.

In 530, the method includes dynamically generating application rendering data for the target device. According to various embodiments, the dynamically generated application rendering data includes common display logic for use by any type of the plurality of rendering platforms, and dynamically determined rendering metadata that is unique to the detected type of rendering platform of the target device and that controls rendering of the common display logic on the target device. In 540, the method includes transmitting the dynamically generated application rendering data to the target device.

In the examples herein, the dynamically determined rendering metadata may include rendering instructions for rendering the common display logic using a native rendering component which is unique to the detected type of rendering platform of the target device. In some embodiments, the dynamically determined rendering metadata may be selected from among a plurality of possible rendering metadata associated with the plurality of possible types of rendering platforms, respectively. The dynamically determined rendering metadata is stored as a JavaScript Object Notation (JSON) data that is downloaded with the common display logic. According to various aspects, the common display logic may include instructions for displaying one or more of a text box, an input field, a radio button, a layout format, and a user interface. Here, the common display logic may be the same regardless of the type of detected rendering platform of the target device.

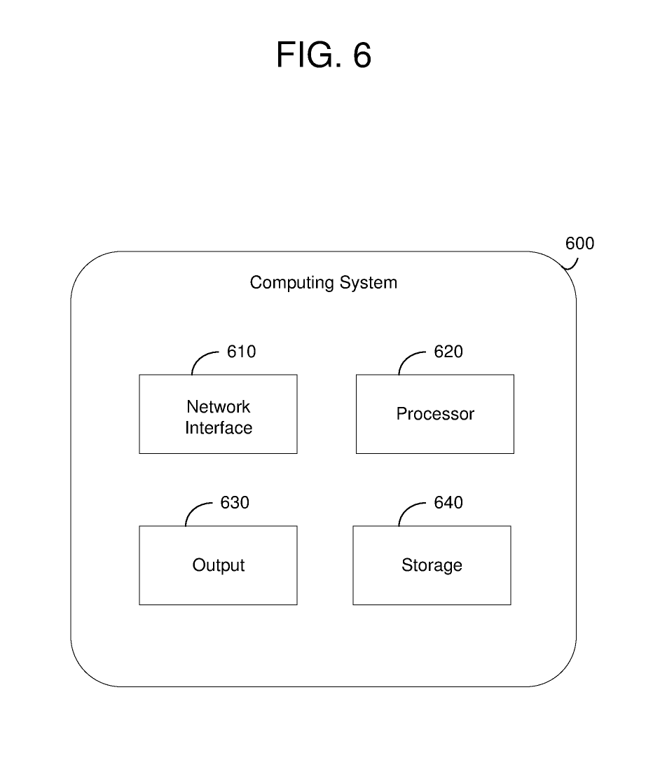

FIG. 6 illustrates a computing system 600 for dynamically generating rendering data for a target device in accordance with an example embodiment. The components of the computing system 600 further described herein may perform the steps of the method 500 described with respect to FIG. 6. For example, the computing system 600 may be a database, cloud platform, streaming platform, and the like. In some embodiments, the computing system 600 may be distributed across multiple devices. Referring to FIG. 6, the computing system 600 includes a network interface 610, a processor 620, an output 630, and a storage device 640 such as a memory. Although not shown in FIG. 6, the computing system 600 may include additional components not specifically shown in the diagram such as a display, an input unit, a receiver, a transmitter, and the like.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the computing system 600, an externally connected display, a display connected to the cloud, another device, and the like. The storage device 640 is not limited to a particular storage device and may include any known memory device such as RAM, ROM, hard disk, and the like, and may or may not be included within the cloud environment. The storage 640 may store software modules or other instructions which can be executed by the processor 620 to perform the method 500 shown in FIG. 5.

According to various embodiments, the network interface 610 may receive a request to download application data to a target device. In response, the processor 620 may detect a type of rendering platform of the target device from among a plurality of possible types of rendering platforms, and dynamically generate application rendering data for the target device. For example, the dynamically generated application rendering data may include common display logic for use by any type of the plurality of rendering platforms, and dynamically determined rendering metadata that is unique to the detected type of rendering platform of the target device and that controls rendering of the common display logic on the target device. Furthermore, the processor 620 may control the network interface 610 to transmit the dynamically generated application rendering data to the target device.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving a request to download application data to a target device;
detecting a type of rendering platform of the target device from among a plurality of types of rendering platforms;
dynamically generating application rendering data for the target device, the dynamically generated application rendering data comprising common logic for use by any type of the plurality of rendering platforms, and dynamic rendering metadata that corresponds to the detected type of rendering platform of the target device and that controls rendering of the common logic on the target device; and
transmitting the dynamically generated application rendering data to the target device.

2. The computer-implemented method of claim 1, wherein the dynamic rendering metadata comprises rendering instructions for rendering the common logic using native rendering components which are unique to the detected type of rendering platform of the target device.

3. The computer-implemented method of claim 1, wherein the detecting the type of rendering platform comprises detecting whether the rendering platform is a mobile operating system of the target device or a web browser of the target device.

4. The computer-implemented method of claim 1, wherein the dynamic rendering metadata is selected from among a plurality of rendering metadata associated with the plurality of types of rendering platforms, respectively.

5. The computer-implemented method of claim 1, wherein the dynamic rendering metadata is stored as a JavaScript Object Notation (JSON) data that is downloaded with the common logic of the application.

6. The computer-implemented method of claim 1, wherein the common logic comprises common display logic which includes instructions for displaying one or more of a text box, an input field, a radio button, a layout format, and a user interface.

7. The computer-implemented method of claim 1, wherein the common logic comprises common display logic which comprises graphical features of the application, and common business logic which comprises a workflow of the application based on selections made on the graphical features.

8. The computer-implemented method of claim 1, wherein the common logic is the same regardless of the type of detected rendering platform of the target device.

9. A computing system comprising:
a network interface configured to receive a request to download application data to a target device; and
a processor configured to detect a type of rendering platform of the target device from among a plurality of types of rendering platforms, and dynamically generate application rendering data for the target device, the dynamically generated application rendering data comprising common logic for use by any type of the plurality of rendering platforms, and dynamic rendering metadata that corresponds to the detected type of rendering platform of the target device and that controls rendering of the common logic on the target device,
wherein the processor is further configured to control the network interface to transmit the dynamically generated application rendering data to the target device.

10. The computing system of claim 9, wherein the dynamic rendering metadata comprises rendering instructions for rendering the common logic using native rendering components which are unique to the detected type of rendering platform of the target device.

11. The computing system of claim 9, wherein the processor is configured to detect whether the rendering platform is a mobile operating system of the target device or a web browser of the target device.

12. The computing system of claim 9, wherein the processor is configured to select the dynamic rendering metadata from among a plurality of rendering metadata associated with the plurality of types of rendering platforms, respectively.

13. The computing system of claim 9, wherein the dynamic rendering metadata is stored as a JavaScript Object Notation (JSON) data that is downloaded with the common logic of the application.

14. The computing system of claim 9, wherein the common logic comprises common display logic which includes instructions for displaying one or more of a text box, an input field, a radio button, a layout format, and a user interface.

15. The computing system of claim 9, wherein the common logic comprises common display logic which comprises graphical features of the application, and common business logic which comprises a workflow of the application based on selections made on the graphical features.

16. The computing system of claim 9, wherein the common logic is the same regardless of the type of detected rendering platform of the target device.

17. A non-transitory computer readable medium having stored therein instructions that when executed cause a computer to perform a method comprising:
receiving a request to download application data to a target device;
detecting a type of rendering platform of the target device from among a plurality of types of rendering platforms;
dynamically generating application rendering data for the target device, the dynamically generated application rendering data comprising common logic for use by any type of the plurality of rendering platforms, and dynamic rendering metadata that corresponds to the detected type of rendering platform of the target device and that controls rendering of the common logic on the target device; and
transmitting the dynamically generated application rendering data to the target device.

18. The non-transitory computer readable medium of claim 17, wherein the dynamic rendering metadata comprises rendering instructions for rendering the common logic using native rendering components which are unique to the detected type of rendering platform of the target device.

19. The non-transitory computer readable medium of claim 17, wherein the detecting the type of rendering platform comprises detecting whether the rendering platform is a mobile operating system of the target device or a web browser of the target device.

20. The non-transitory computer readable medium of claim 17, wherein the dynamic rendering metadata is selected from among a plurality of rendering metadata associated with the plurality of types of rendering platforms, respectively.
